(19) United States
(12) Patent Application Publication
(10) Pub. No.: US 2005/0094162 A1
(43) Pub. Date: May 5, 2005

(54) Scan subsystem generation of document processing data

(75) Inventor: Andrew Rodney Ferlitsch, Tigard, OR (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/696,936

(22) Filed: Oct. 30, 2003

(51) Int. Cl. G06F 15/00

(52) U.S. Cl. 358/1.6; 358/1.13

(57) ABSTRACT

A scan subsystem document processing method is provided, along with a system for converting graphics device interface (GDI) data into document processing application data. The method comprises: at a scan subsystem, accepting scan data; converting the scan data into device dependent interface (DDI) data; converting the DDI data to GDI data; accepting the GDI data at a document processing application; converting the GDI data into an internal representation (IR) data format proprietary to the document processing application; parsing the IR data into a standard language document format specified for use with the document processing application; and, (optionally) saving the standard language document in storage memory. The document processing application can be a text, vector, or graphics applications.

### RELATED APPLICATIONS

This application is a continuation-in-part of a pending application entitled, PSEUDO PRINT JOB SYSTEM AND METHOD FOR SCAN JOB DESPOOLING, invented by Andrew Ferlitsch, Ser. No. ______, filed on Oct. 10, 2003, Attorney Docket SLA1232.

This application is a continuation-in-part of a pending application entitled, SCAN DESCRIPTION LANGUAGE, invented by Andrew Ferlitsch, Ser. No. ______, filed on Oct. 23, 2003, Attorney Docket SLA1241.

### BACKGROUND OF THE INVENTION

1. Field of the Invention

This invention generally relates to digital document imaging processes and, more particularly, to a system and method for using a scan subsystem to generate a source data for a document processing application.

2. Description of the Related Art

In the Microsoft (MS) family of operating systems, MS conformant applications conform to the MS print subsystem for printing. This allows users of an arbitrary MS conformant application to print a document from within the application through a single system interface, such as a “File” menu with a “Print” submenu, referred to herein as File>Print. This MS print subsystem provides a universal method for applications to output documents, independent of the destination printing device. The menu-driven applications, associated with other conventional operating systems operate in a similar manner.

In the MS family of operating systems, however, there is no equivalent concept, or universal means for inputting a document into a document processing application, independent of the source scanning device. Generally, a user adds a document into a MS conformant application using the following steps:

1. Scan the image using a separate process/application.

2. Convert the image into a Microsoft bitmap using an image manipulation application.

3. Copy/Paste the bitmap into the destination application.

FIG. 1a is a depiction of an MS print subsystem (prior art). In the MS print subsystem, a user typically prints a document through the following steps:

1. Load the document(s) into an application associated with the document format.

2. Select File>Print from the main menu bar.

3. Select an installed printer from the File>Print menu.

4. Select general printing options, such as collate, number of copies, or page range, from the File>Print menu.

5. Select printer specific printing options, such as stapling, or duplex printing, from printer specific submenu (i.e., Properties).

The application converts the document data into printing instructions using a graphics device interface (GDI) format, by calling GDI functions with the printer as the device context. GDI data is converted into operating system (OS) specific device dependent interface (DDI) data. The DDI data is then passed to the printer driver associated with the selected (installed) printer. In another mode of operation, the DDI data is journaled (e.g., EMF in the context of MS) and initially spooled to the print spooler. The journaled DDI data is then subsequently, immediately or delayed, played back to the printer driver associated with the selected printer as a background process.

The printer driver converts the DDI data into rendered (Raw) data. The rendered data is spooled to a print spooler. The print spooler schedules the spool data for printing. Either immediately, or at some later time, the print spooler despools the spool data to the print processor associated with the installed printer.

If the spool data is journaled, the print processor plays back the spool data to the printer driver associated with the installed printer. The printer driver then renders the data into rendered data and respools the rendered data to the print spooler.

If the spool data is rendered immediately, the print processor writes the spool data to the port manager associated with the installed printer. The port manager despools the spool data to a corresponding printing device.

FIG. 1b is a more detailed depiction of the print subsystem of FIG. 1a (prior art). Below is a more detailed explanation of the application and OS processes associated with printing a document through the MS print subsystem:

1. A document in a format specific to the document processing application is loaded into the application.

2. The application parses the document and converts the document data format into an internal representation (IR).

3. The IR of the document data may be edited by the user and updated.

4. When the user selects OK on the File>Print menu, the IR is passed to the IR compiler for conversion into a sequence of GDI function calls and arguments.

5. The operating system passes the GDI calls from the application to GDI.

6. GDI converts the calls to conform to the DDI printer driver interface.

7. GDI passes the DDI converted calls to the printer driver associated with the installed printer with the printer driver's DDI interface.

8. The printer driver converts the DDI data into rendered print data and spools the print data to the spooler.

FIG. 1c is an illustration of a typical File>Print menu. This particular illustration is a screen snapshot of the Microsoft Word® application on Microsoft Windows NT 4.0®. The File>Print menu separates the selection of printing options into 3 parts:

A. Selection of installed printer.

B. Selection of printer independent options on main menu, such as the Microsoft common print dialog.

C. Selection of installed printer specific options from the properties menu via the properties button.

FIG. 1d is a depiction of conventional scan subsystem (prior art). Scanning is treated as a separate operation from printing, and there is no universal way to input data into a document processing application from a scanning device. To scan a document into an existing electronic document of an arbitrary document processing application format, the following steps occur:

1. Invoke a scan driver, such as a Twain driver, to scan in document(s) to the client computing device.

2. Load scanned image data into an image manipulation application, such as Adobe Photoshop®.

3. Use the image manipulation application to convert the scanned image data into a MS bitmap.

4. Load the converted MS bitmap into the document format specific to a document processing application.

It would be advantageous if a scan data could be entered into any document processing application using a universal scan subsystem process.

### SUMMARY OF THE INVENTION

The present invention differs from the prior art in that printing and scanning may be integrated into the same application/OS device subsystem. If so, the user inputs a scan image (scan data) into a document processing application by selecting an installed scanner through the integrated print/scan subsystem via a File>Print/Scan menu. The scanner driver associated with the installed scanner converts the scanned image data into GDI data. The GDI compiler is changed from a one-way output device (GDI>DDI), as is commonly associated with a print subsystem, into a two-way input/output device (DDI<>GDI). The document processing application conformance is changed from a one-way output only document conversion (IR>GDI), into a two-way input/output document conversion (GDI<>IR). Further, the document processing application need not be restrained to a one-way output only document conversion (application specific format>IR), and may use a two-way input/output document conversion (application specific format<>IR).

Accordingly, a scan subsystem document processing method is provided. The method comprises: at a scan subsystem, accepting scan data; converting the scan data into DDI data; converting the DDI data to GDI data; at a document processing application, accepting the GDI data; converting the GDI data into an internal representation (IR) data format proprietary to the document processing application; parsing the IR data into a standard language document format specified for use with the document processing application; and, (optionally) saving the standard language document in storage memory. The document processing application can be a text, vector, or graphics applications.

Additional details of the above-described method, and a system for converting GDI data into document processing application data, are provided below.

### BRIEF DESCRIPTION OF THE DRAWINGS

FIG. 1a is a depiction of an MS print subsystem (prior art).

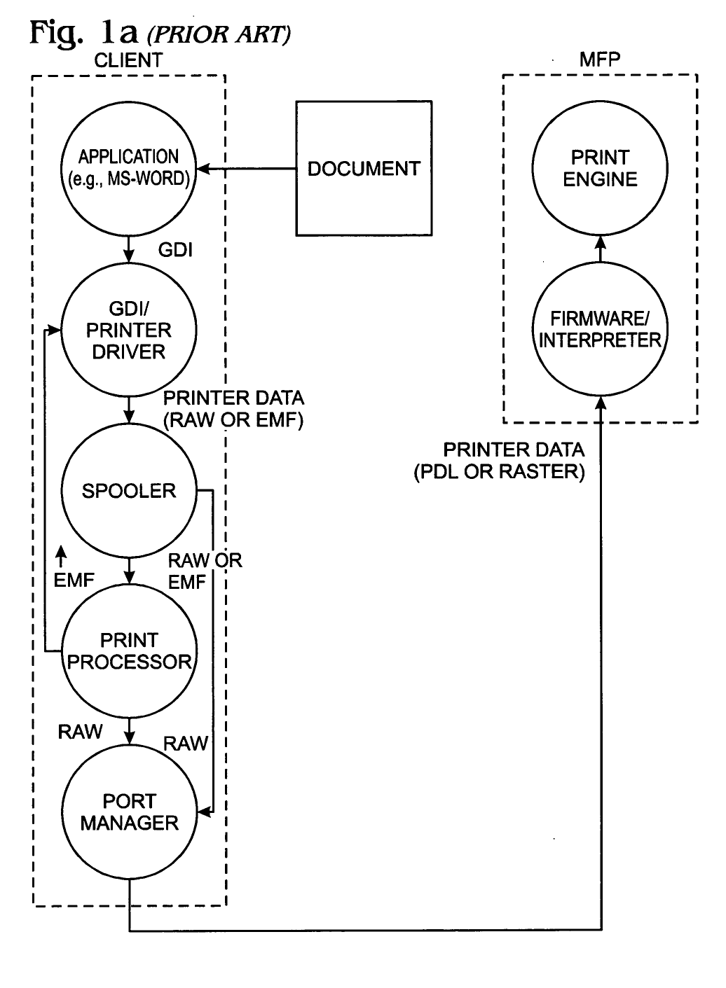

FIG. 1b is a more detailed depiction of the print subsystem of FIG. 1a (prior art).

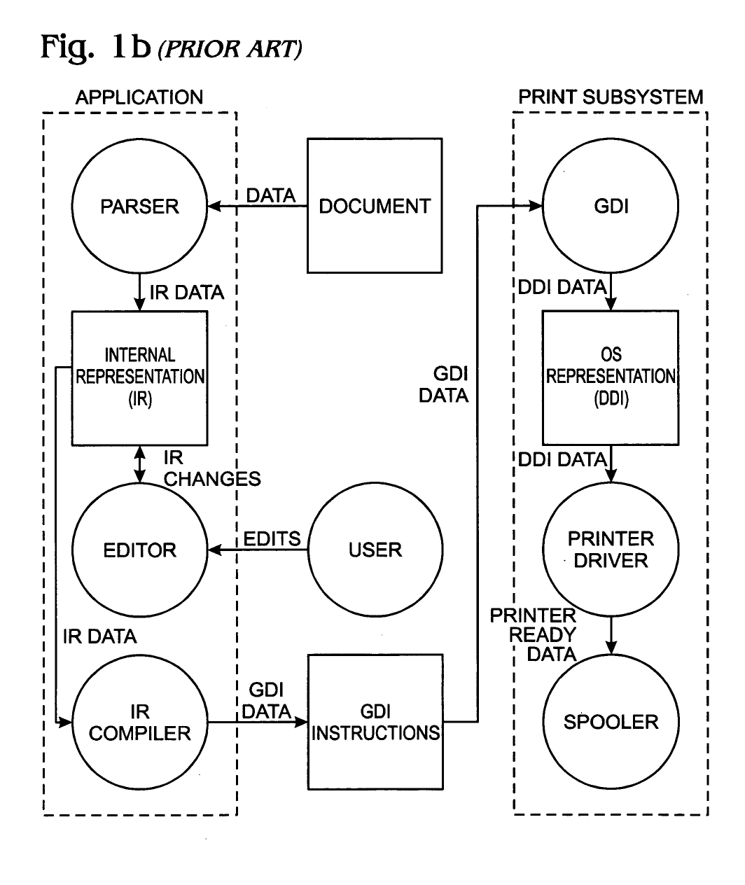

FIG. 1c is an illustration of a typical File>Print menu.

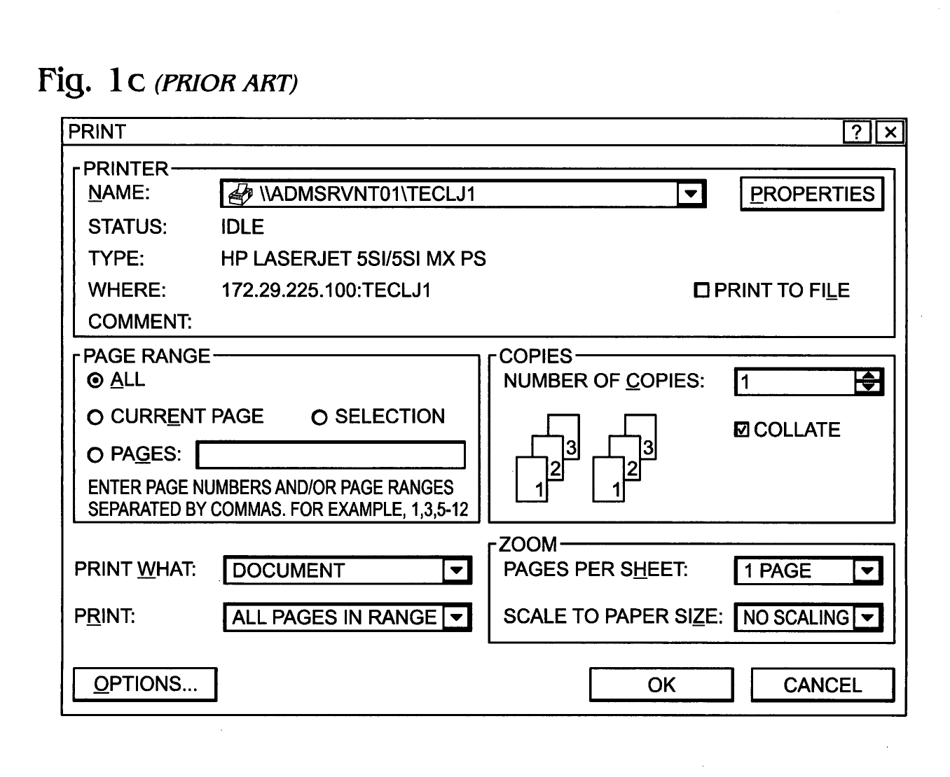

FIG. 1d is a depiction of conventional scan subsystem (prior art).

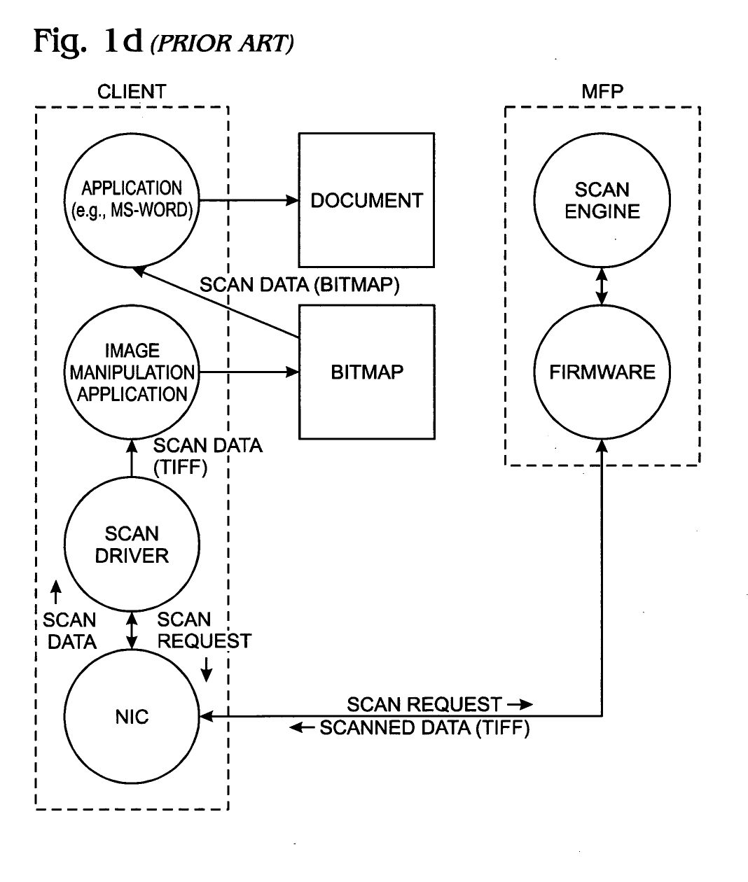

FIG. 2 is a schematic block diagram of the present invention system for converting GDI data into document processing application data.

FIG. 3 is an example of the system of FIG. 2 in operation.

FIG. 4 is a diagram depicting aspects of FIG. 3 in greater detail.

FIG. 5 is an illustration of an exemplary File>Scan menu, as might be used with the present invention.

FIGS. 6a and 6b are flowcharts illustrating the present invention scan subsystem document processing method.

### DETAILED DESCRIPTION OF THE PREFERRED EMBODIMENTS

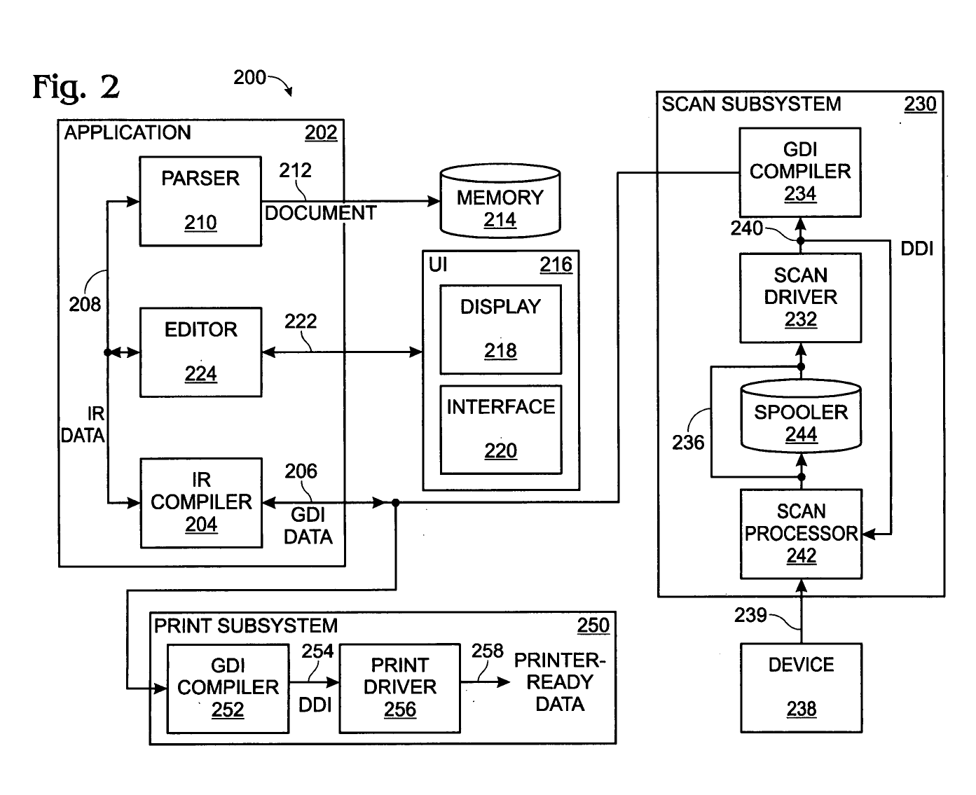

FIG. 2 is a schematic block diagram of the present invention system for converting GDI data into document processing application data. The system 200 comprises a document processing application 202. The document processing application includes an internal representation (IR) complier 204 having an interface on line 206 to accept GDI data and an interface on line 208 to supply the GDI data converted into an IR data format proprietary to the document processing application. It should be understood that a document processing application is typically a list of software instructions, accessible in memory (not shown), that are performed by a processor (not shown). As such, the application components, such as the IR compiler 204, are software routines.

The document processing application can be a text application such as MS Microsoft Word® or Corel WordPerfect®, a vector or line art application such as Microsoft Draw®, or a graphics application such as Abode Acrobat® or Microsoft Paint®. These are just a few examples of the applications that can be enabled using the present invention. The document processing application 202 further includes a parser 210 having an interface on line 208 to accept the IR data and an interface on line 212 to supply a standard language document format specified for use with the document processing application. Using Microsoft as an example, the document format names correspond to the application name. Thus, the format for MS-Word is Word. In one aspect, the system 200 further comprises a memory 214 having an interface on line 212 to accept the standard language document for persistent storage. For example, the document can be stored in a hard disk or floppy disk memory.

In other aspects, the system 200 further comprises a user interface (UI) 216 including a display 218 to display the IR data and an interface 220, such as a mouse/keyboard, to accept user commands. An interface on line 222 supplies IR data to the UI 216, and accepts user commands. The document processing application 202 further includes an editor 224 having an interface on line 208 to accept the IR data, and an interface on line 222 to supply the IR data to the UI 216 and accept the user commands. The interface on line 208 then supplies IR data manipulated in response to the user commands. In the context of a text document processing application for example, the manipulations may include actions such as editing the text, sending the document to the print subsystem for printing, or viewing text on a display. In other aspects, the system 200 further comprises a scan subsystem 230 including a scan driver 232 and a GDI compiler 234. The scan driver 232 has an interface on line 236 to accept scan data from device 238. Device 238 can be a scanning device, such as a scanner or multifunctional peripheral (MFP), a facsimile device, an electronic whiteboard, a tablet personal computer, or a storage device, having an interface on line 239 to supply scan data to the scan driver 232. The scan driver 232 and the device 239 are operatively connected, or connected through intervening elements as explained below. The scan driver 232 also has an interface on line 240 to supply scan data converted into DDI data. In another aspect, the scan driver 232 may include a scan processor as a separate process that converts the scan data into DDI data.

The GDI compiler 234 has an interface on line 240 to accept DDI data and an interface on line 206, connected to the document processing application 202, to supply DDI data converted into GDI data. More specifically, the scan driver 232 accepts proprietary formatted scan data and converts the proprietary scan data to an operating system (OS) specific DDI data format. Then, the GDI compiler 234 converts OS specific DDI data to a standard GDI data format.

The scan subsystem 230 further includes a scan processor 242 for performing preprocessing operations on scan data, such as spooling. The scan processor 242 has an interface 239 to accept scan data and an interface on line 236 to supply the scan data. The scan data can either be rendered, in a proprietary or industry standard data format (such as TIFF), or journaled scan data (DDI). A spooler 244 has an interface on line 236 to accept scan data from the scan processor and an interface to supply scan data to the scan driver 232. In some aspects of the system, a ‘scan directly from scanner’ function can be scheduled that bypasses the spooler 244. This direct function is equivalent to the MS ‘print directly to printer’ function.

Rendered scan data can be despooled from the spooler 244 and processed into DDI, and then GDI data, in a single operation. As used herein, “rendered scan data” is understood to be scan subsystem-ready data. Journaled scan data is processed in two spooling steps. After the scan data is initially spooled, the scan driver 232 converts scan data to DDI data, sends the DDI data to the scan processor 242, and the DDI data is spooled. Subsequently, the DDI data is despooled and sent to the scan driver 232 for conversion. The scan driver 232 converts the DDI data (using the GDI compiler 234) into GDI data on the second pass.

As described above, the present invention system can be enabled between the document processing application 202 and the scan subsystem 230. In other aspects, the invention can be enabled with a parallel print subsystem (as shown for clarity), or a combination scan/print subsystem. Then, the IR compiler 204 interface on line 208 accepts IR data from the parser 210 and the interface on line 206 supplies IR data converted into GDI data.

A print subsystem 250 includes a GDI compiler 252 having an interface on line 206 to accept GDI data from the IR compiler 204 and an interface on line 254 to supply GDI data converted to DDI data. A print driver 256 has an interface on line 254 to accept the DDI data and an interface on line 258 to supply printer-ready data to a printer (not shown). If a combination scan/print subsystem is enabled, then GDI compiler 234 would convert from DDI data to GDI data, as well as from GDI data to DDI data. In the combination aspect, the scan driver 232 may also function a print driver, accepting DDI data and converting it into a printer-ready format.

### Functional Description

Combined GDI Print and Scan Subsystem—Overview

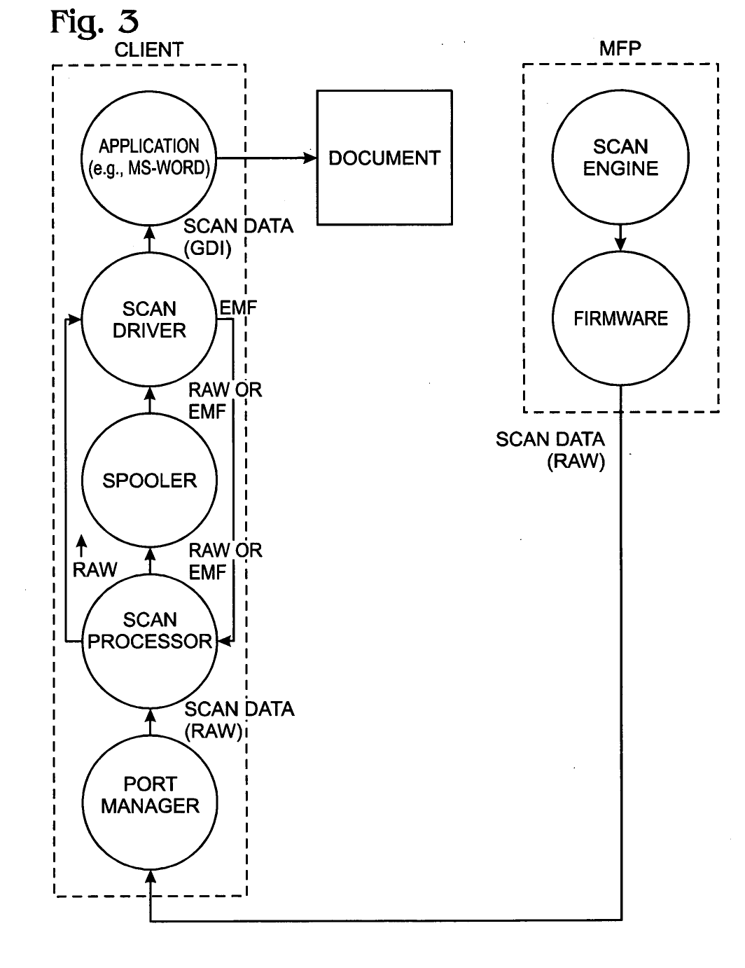

FIG. 3 is an example of the system of FIG. 2 in operation. In this aspect of the invention, the user installs a scanner or MFP on a client computing device, similar to the manner in which a printer is installed when using MS Word for example. These steps include:

1. Invoking an OS built-in function or Install Script to ‘Add a Scanner’

2. Defining a name for the installed scanner.

3. Selecting default settings for the installed scanner.

4. Associating a custom or default scan processor with the installed scanner.

5. Associating a port with the installed scanner.

A document(s) is scanned on a scanner or MFP device and is converted into some scanned image format, referred to herein as Raw scan data. For illustrative purposes only, the format is assumed to be TIFF, but the invention is not limited to any particular format. The scanned image data is then either pushed to, or pulled by the destination client computing device.

The scanner or MFP device is connected to the destination via a port, such as a local or network port, in the same manner as a printer is connected. The port and protocol associated with the scanning device is a two-way data transmission (input/output). Alternately, the port/protocol is a one-way data transmission (input only), and the scan subsystem is independent of the print subsystem.

The scanned image data (scan data) is received at the port and passed onto a scan processor that is associated with the port for the selected installed scanner. The scan processor can operate in several modes, such as, but not limited to:

1. Scan directly from scanner.

2. Spool the scan data.

3. Journal the scan data.

If the mode is ‘scan directly from scanner’, the scan processor passes the scan image data (Raw) directly to the scan driver associated with the installed scanner. The scan driver converts the scan data to GDI data. The GDI data is passed (inputted) to the document processing application (application) and the application converts the GDI data to a corresponding document format.

If the mode is ‘spool the scan data’, the scan processor spools the scan data to the spooler. The spooler, immediately or delayed, despools the scan data to the scan driver associated with the installed scanner. The scan driver converts the scan data to GDI data and passes the GDI data to the application as described above.

If the mode is ‘journal the scan data’, the scan processor spools the scanned image data to the spooler. The spooler, immediately or delayed, despools the scan data to the scan driver associated with the installed scanner. The scan driver journals the scan data for deferred GDI conversion and respools the journaled scan data to the spooler. The spooler, immediately or delayed, despools the journaled scanned image to the scan driver. The scan driver converts the journaled scan data (DDI data) into GDI data. The GDI data is passed to the application as described above.

Combined Print and Scan Subsystem—Application/OS Internals

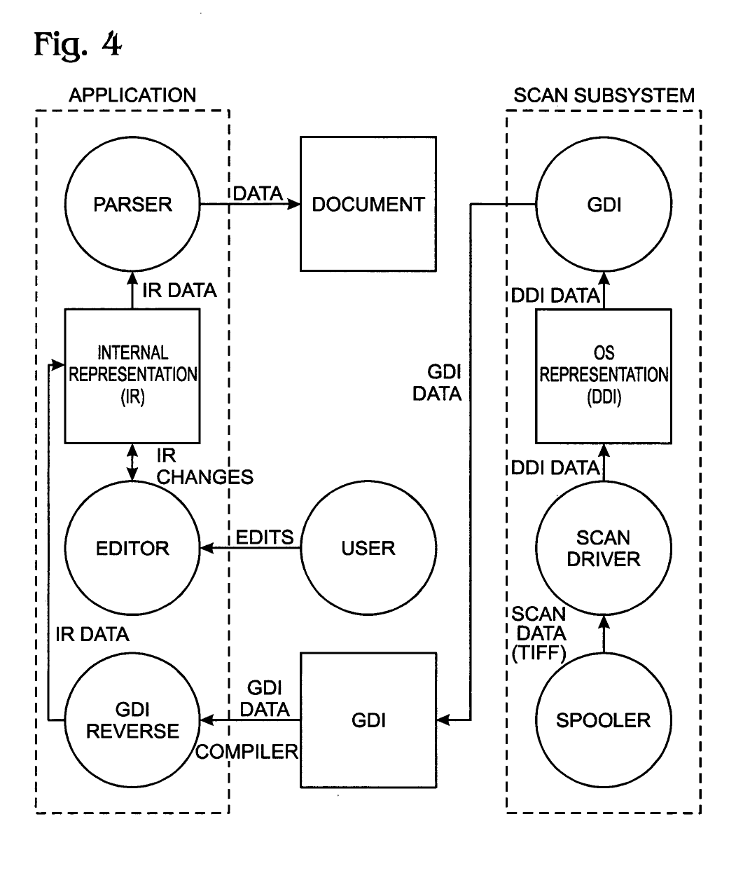

FIG. 4 is a diagram depicting aspects of FIG. 3 in greater detail. A more detailed explanation of the application and OS is provided, as a document is passed to the application. The process is as follows:

1. The spooler sends the scanned image data, for example TIFF, to the scan driver associated with the installed scanner, the scanning device selected by user for input into the application.

2. The scan driver converts the scan data into DDI calls/arguments.

3. The DDI calls/arguments are passed as input to GDI. This is the opposite of the printing process where GDI data is converted to OSDDI calls/arguments.

4. The DDI calls/arguments are converted to GDI data. One representation of the GDI data may be a sequence of input based GDI calls (output based), such as:

Scanning Printing Equivalent

| | |
|---|---|
| InputTextOut(...) | TextOut(...) |
| InputSetFont(...) | SetFont(...) |

Another representation is an array or link list of data structures, such as:

| Type | Arg1 Type | Arg1 | Arg2 Type | Arg2 | Arg3 Type | Arg3 |
|---|---|---|---|---|---|---|
| TextOut | INTPAIR | 0,0 | INTPAIR | 100,100 | STRING | “abc” |

5. The GDI data is read in by the application.

6. The application converts the GDI data to IR using an IR Compiler, used in reverse with respect to the printing context.

7. The IR data may then be edited or manipulated by the user.

8. The document format parser takes the IR as input (the reverse of the printing context), and converts the IR data into the document format compliant with the particular document processing application.

Combined Print and Scan Subsystem—User Interface

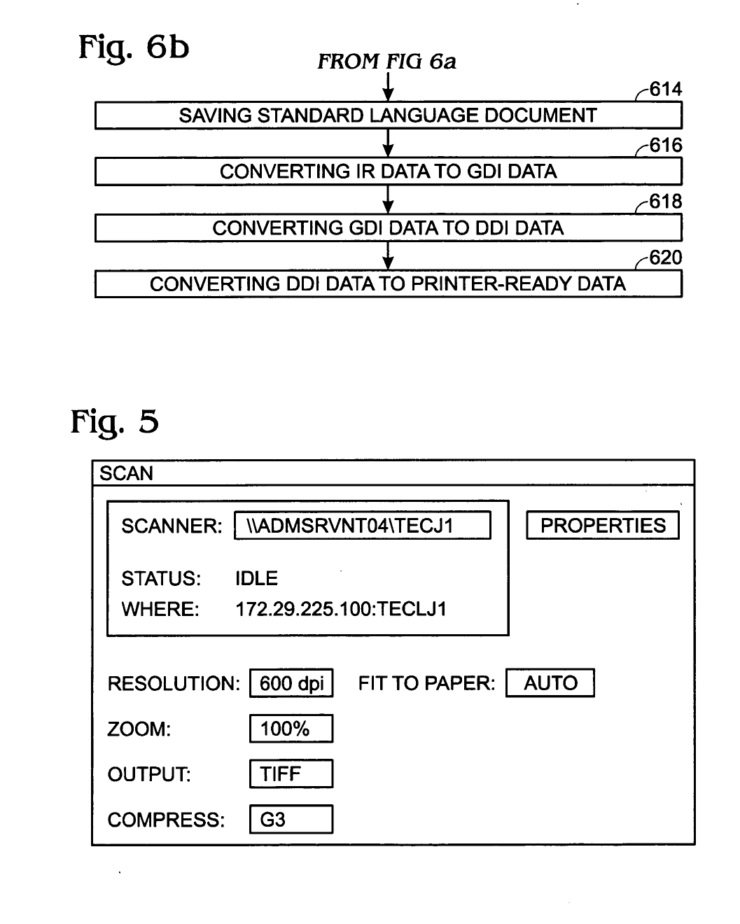

FIG. 5 is an illustration of an exemplary File>Scan menu, as might be used with the present invention. The File>Scan menu provided by the application in this illustration separates the selection of scanning options into 3 parts:

A. Selection of installed scanner.

B. Selection of scanner independent options on main menu.

C. Selection of installed scanner specific options from the properties menu via the properties button.

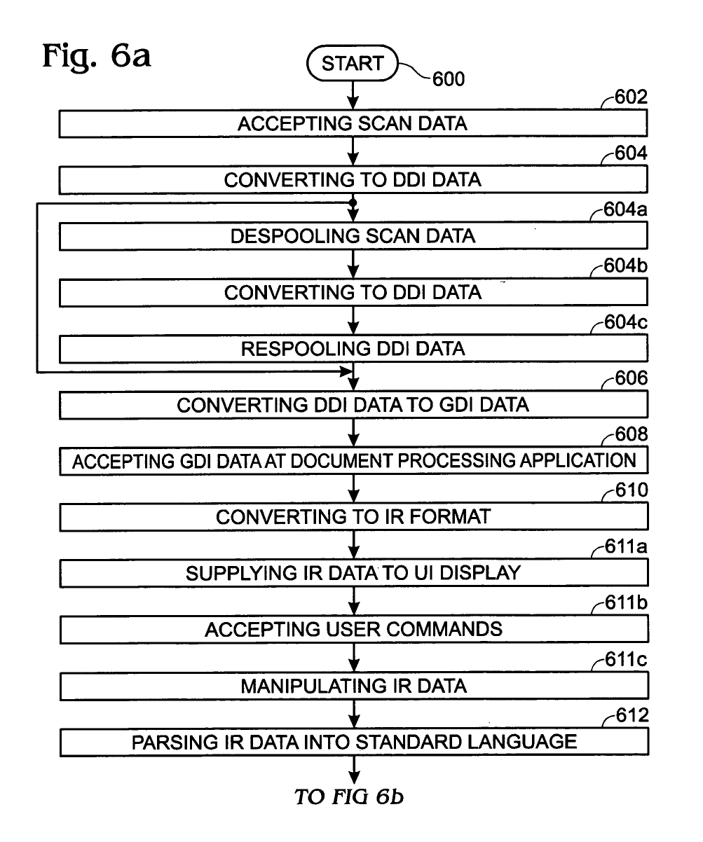

FIGS. 6a and 6b are flowcharts illustrating the present invention scan subsystem document processing method. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 600.

Step 602 accepts scan data at a scan subsystem from a device such as a scanning device (scanner or MFP), facsimile device, electronic whiteboard, tablet personal computer, or a storage device. Step 604 converts the scan data into DDI data. Step 606 converts the DDI data to GDI data. Step 608 accepts GDI data at a document processing application selected from the group including text, vector, and graphics applications. Step 610 converts the GDI data into an IR data format proprietary to the document processing application. Step 612 parses the IR data into a standard language document format specified for use with the document processing application. In some aspects, Step 614 saves the standard language document in storage memory.

In other aspects, Step 611a supplies the IR data to a user interface (UI) display. Step 611b accepts user commands at the UI. Step 611c manipulates the IR data in response to the user commands. As noted above, the manipulations can include viewing, printing, and editing the IR data.

More specifically, accepting scan data in Step 602 may include accepting proprietary formatted scan data. Then, converting the scan data into DDI data (Step 604) includes converting the proprietary scan data to an operating system (OS) specific DDI data format, and converting the DDI data to GDI data (Step 606) includes converting the OS specific DDI data to a standard GDI data format.

In some aspects, converting scan data to DDI data includes converting journaled scan data. Then, Step 604 includes substeps. Step 604a despools the scan data (the scan data may be initially spooled, regardless of whether it is rendered or journaled). Step 604b converts the scan data to DDI data. Step 604c respools the DDI data. Then, Step 606 subsequently despools the DDI for conversion into GDI data.

As noted above, the present invention can be considered to be operating in parallel with a print subsystem. In that case, the method comprises further steps. Step 616 converts IR data into GDI data. Step 618 converts the GDI data into DDI data at a print subsystem, and Step 620 converts the DDI data into printer-ready data.

A system and method have been provided for the sourcing of documents, to a document processing application, from a scan subsystem. The invention is not limited to any particular network environment. Alternately stated, the document processing application and scan subsystem may be either locally or network-connected. Examples of typical operations have been given to clarify, however, the invention is not limited to these examples.

Although the invention has generally been explained in the context of a Microsoft Windows operating system, the invention can also be practiced with the scan, spooling, and despooling subsystems of a Apple MacIntosh Operating System, Linux Operating System, System V Unix Operating Systems, BSD Unix Operating Systems, OSF Unix Operating Systems, Sun Solaris Operating Systems, HP/UX Operating Systems, or IBM Mainframe MVS and AS/400 Operating System, to name a limited list of other possibilities. Other variations and embodiments of the invention will occur to those skilled in the art.

1. A scan subsystem document processing method, the method comprising:
at a document processing application, accepting graphics device interface (GDI) data; and,
converting the GDI data into an internal representation (IR) data format proprietary to the document processing application.

2. The method of claim 1 further comprising:
parsing the IR data into a standard language document format specified for use with the document processing application; and,
saving the standard language document in storage memory.

3. The method of claim 1 further comprising:
supplying the IR data to a user interface (UI) display;
accepting user commands at the UI; and,
manipulating the IR data in response to the user commands.

4. The method of claim 1 wherein accepting GDI data at a document processing application includes accepting the GDI data at a document processing application selected from the group including text, vector, and graphics applications.

5. The method of claim 1 further comprising:
at a scan subsystem, accepting scan data;
converting the scan data into device dependent interface (DDI) data; and,
converting the DDI data to GDI data.

6. The method of claim 5 wherein accepting scan data includes accepting proprietary formatted scan data;
wherein converting the scan data into DDI data includes converting the proprietary scan data to an operating system (OS) specific DDI data format; and,
wherein converting the DDI data to GDI data includes converting the OS specific DDI data to a standard GDI data format.

7. The method of claim 5 wherein accepting scan data includes accepting scan data from a device selected from the group including a scanning device, facsimile device, electronic whiteboard, tablet personal computer, and a storage device.

8. The method of claim 5 wherein converting scan data to DDI data includes converting journaled scan data.

9. The method of claim 8 wherein converting journaled scan data includes:
despooling the scan data;
converting the scan data to DDI data;
respooling the DDI data; and,
wherein converting the DDI data to GDI data includes subsequently despooling the DDI for conversion into GDI data.

10. The method of claim 1 further comprising:
converting IR data into GDI data;
at a print subsystem, converting the GDI data into DDI data;
converting the DDI data into printer-ready data.

11. A system for converting graphics device interface (GDI) data into document processing application data, the system comprising:
a document processing application including:
an internal representation (IR) complier having an interface to accept GDI data and an interface to supply the GDI data converted into an IR data format proprietary to the document processing application.

12. The system of claim 11 wherein the document processing application further includes:
a parser having an interface to accept the IR data and an interface to supply a standard language document format specified for use with the document processing application.

13. The system of claim 12 further comprising:
a user interface (UI) including a display to display the IR data, an interface to accept user commands, and an interface to supply the accepted user commands; and,
wherein the document processing application further includes:
an editor having an interface to accept the IR data, an interface to supply the IR data to the UI, an interface accept the user commands, and an interface to supply IR data manipulated in response to the user commands.

14. The system of claim 11 wherein the document processing application is selected from the group including text, vector, and graphics applications.

15. The system of claim 11 further comprising:
a scan subsystem including:
a scan driver having an interface to accept scan data and an interface to supply scan data converted into device dependent interface (DDI) data; and,
a GDI compiler having an interface to accept DDI data and an interface connected to the document processing application to supply DDI data converted into GDI data.

16. The system of claim 15 wherein the scan driver accepts proprietary formatted scan data and converts the proprietary scan data to an operating system (OS) specific DDI data format; and,
wherein the GDI compiler converts OS specific DDI data to a standard GDI data format.

17. The system of claim 15 further comprising:
a device, selected from the group including a scanning device, facsimile device, electronic whiteboard, tablet personal computer, and a storage device, having an interface to supply scan data to the scan driver.

18. The system of claim 15 wherein the scan subsystem further includes:
a scan processor for performing preprocessing operations on scan data, having an interface to accept scan data, and an interface to supply the scan data, the scan data being selected from the class including rendered and journaled scan data; and,
a spooler having an interface to accept scan data from the scan processor and an interface to supply scan data to the scan driver.

19. The system of claim 18 wherein the scan driver converts scan data to DDI data, and sends the DDI data to the scan processor;
wherein the scan processor sends the DDI data to the spooler for respooling; and,
wherein the scan driver subsequently despools the DDI data for conversion into GDI data.

20. The system of claim 11 wherein the IR compiler has an interface accept IR data from the parser and an interface to supply IR data converted into GDI data;
the system further comprising:
a print subsystem including:
a GDI compiler having an interface to accept GDI data from the IR compiler and an interface to supply GDI data converted to DDI data; and,
a print driver having an interface to accept the DDI data and an interface to supply printer-ready data.

21. The system of claim 12 further comprising:
a memory having an interface to accept the standard language document for persistent storage.
